(19) United States
(12) Patent Application Publication
(10) Pub. No.: US 2023/0271145 A1
(43) Pub. Date: Aug. 31, 2023

(54) ROBUST NANOFILMS PREPARED FROM SUSTAINABLE MATERIALS

(71) Applicant: King Abdullah University of Science and Technology, Thuwal (SA)

(72) Inventors: Sang-Hee PARK, Thuwal (SA); Gyorgy SZEKELY, Thuwal (SA)

(21) Appl. No.: 17/928,638

(22) PCT Filed: May 26, 2021
(86) PCT No.: PCT/IB2021/054615

§ 371 Date: Nov. 30, 2022

Related U.S. Application Data
(60) Provisional application No. 63/033,099, filed on Jun. 1, 2020.

(51) Int. Cl. B01D 69/12; B01D 61/02; B01D 67/00; B01D 69/02; C02F 1/44; B01D 71/60; B01D 71/08; B01D 71/74

(52) U.S. Cl. CPC B01D 69/1251; B01D 61/027; B01D 67/0006; B01D 69/02; C02F 1/442; B01D 71/60; B01D 71/08; B01D 71/74; B01D 2325/04; B01D 2325/34; B01D 2323/40

(57) ABSTRACT

Embodiments include nanofilms comprising the reaction product of a natural building block type A including at least two functional groups and a natural building block type B including at least three functional groups, wherein the natural building block type A and the natural building block type B react to form a branched polymer network including solvent-resistant bonds.

### BACKGROUND

Organic solvent nanofiltration (OSN) is considered to be an emerging technology for separating molecules having molecular weights in the range of 100-2000 g mol⁻¹. While OSN may be efficient and may require less energy, it requires thin film composite membranes that are highly stable, solvent-resistant, and operable under harsh conditions. Conventional state-of-the-art thin film composite membranes having these characteristics are all made of petrochemical-based building blocks and polymers. In addition, the solvents required to fabricate these membranes are not environmentally friendly and are often hazardous. It therefore remains an ongoing challenge to fabricate thin film composite membranes from environmentally benign materials that exhibit good performance and that have the properties and characteristics suitable for organic solvent nanofiltration.

### SUMMARY

In some aspects of the invention, a nanofilm may include the reaction product of a natural building block type A including at least two functional groups and a natural building block type B including at least three functional groups, wherein the natural building block type A and the natural building block type B react to form a branched polymer network including solvent-resistant bonds.

In further aspects of the invention, a method of fabricating a nanofilm may include one or more of the following steps: preparing a precursor solution A including a natural building block type A dissolved in a green solvent A, wherein the natural building block type A includes two or more functional groups; preparing a precursor solution B including a natural building block type B dissolved in a green solvent B, wherein the natural building block type B includes three or more functional groups; and contacting the precursor solution A and the precursor solution B to form, by interfacial polymerization, to form a branched polymer network including solvent-resistant bonds.

In some further aspects of the invention, a method of fabricating a nanofilm may include one or more of the following steps: preparing a precursor solution A including a plurality of natural building blocks A dissolved in a green solvent A, each of the plurality of natural building blocks A including two or more functional groups; preparing a precursor solution B including a plurality of natural building blocks B dissolved in a green solvent B, each of the plurality of natural building blocks B including three or more functional groups; and contacting the precursor solution A and the precursor solution B in a reaction vessel to form, by interfacial polymerization, a freestanding nanofilm.

In yet further aspects of the invention, a method of fabricating a nanofilm may include one or more of the following steps: preparing a precursor solution A including a plurality of natural building blocks A dissolved in a green solvent A, each of the plurality of natural building blocks A including two or more functional groups; preparing a precursor solution B including a plurality of natural building blocks B dissolved in a green solvent B, each of the plurality of natural building blocks B including three or more functional groups; immersing a porous substrate in the precursor solution A; removing the porous substrate from the precursor solution A and optionally excess precursor solution A from the porous substrate; and immersing the porous substrate in the precursor solution B to form, by interfacial polymerization, a nanocomposite film.

### BRIEF DESCRIPTION OF THE DRAWINGS

FIG. 1 is a flowchart of a method of making a nanofilm, according to one or more embodiments of the invention.

FIG. 2 is a flowchart of a method of making a freestanding nanofilm, according to one or more embodiments of the invention.

FIGS. 3A-3C are schematic diagrams illustrating interfacial polymerization steps for fabricating freestanding nanofilms, according to one or more embodiments of the invention.

FIG. 4 is a flowchart of a method of making a nanocomposite film, according to one or more embodiments of the invention.

FIG. 5 is a schematic diagram illustrating interfacial polymerization steps for fabricating a nanocomposite film, according to one or more embodiments of the invention.

FIGS. 6A-6E are graphical views of solvent-resistant bonds formed by Michael addition and Schiff base reactions involving non-synthetic building blocks A and non-synthetic building blocks B: (A) solid-state ¹³C NMR spectrum of film including tannic acid priamine; (B) ATF FT-IR spectra of a film including chitosan and 2,5-diformylfuran (top) and a film including tannic acid and priamine (bottom); (C) wide XPS spectra of a film including chitosan and 2,5-diformylfuran (top) and a film including tannic acid and priamine (bottom); (D) deconvoluted high-resolution C1s peaks in the wide XPS spectrum of a film including tannic acid and priamine; and (E) deconvoluted high-resolution N1s peaks in the wide XPS spectrum of a film including tannic acid and priamine, according to one or more embodiments of the invention.

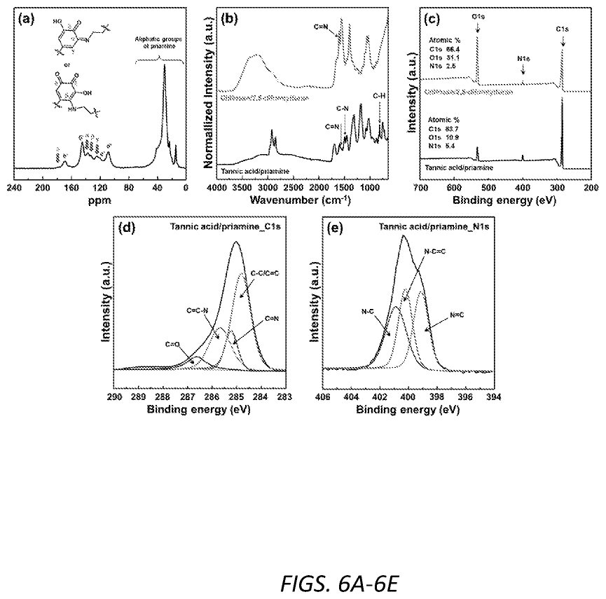

FIG. 7 is a schematic diagram of a multistage crossflow nanofiltration apparatus used for filtration tests of the nanofilms and nanocomposites, according to one or more embodiments of the invention.

### DETAILED DESCRIPTION

### Definitions

As used herein, the term “nanofilm” refers to a material having at least one dimension in the nanometer-sized range. Unless otherwise provided, the term includes both freestanding nanofilms and nanocomposite films which include a nanofilm supported on a porous substrate. A nanofilm may form all or at least a portion of a thin film composite membrane. For example, nanofilms may be used as nanofilm selective layers of thin film composite membranes (e.g., ultrathin nanofilm selective layers). Nanofilms may also be used as the thin film composite membranes themselves. A nanofilm may be referred to as a sustainable nanofilm where said nanofilm is prepared from one or more of green materials, environmentally friendly materials, sustainable materials, renewable materials, natural materials, non-synthetic materials, and the like.

As used herein, the term “natural building block” refers to a difunctional and/or polyfunctional compound derived from one or more of sustainable materials, renewable materials, and natural materials. For example, a natural building block includes a building block which is not synthetic—e.g., a non-synthetic building block. The term “derived” includes compounds extracted, isolated, purified, or otherwise obtained from one or more of said materials and thus may be used broadly to include compounds that are non-synthetic, made in nature, exist in nature, and/or sourced (e.g., derived) from a material which exists in nature. The term thus may include compounds that have been subjected to processing. For example, natural extracts may be subjected to separation processes, isolation processes, purification processes, and the like to obtain natural building blocks. Illustrative examples of natural building blocks include, without limitation, tannic acid derived from oak bark, priamine derived from corn, chitosan derived from shrimp shells, 2,5-diformylfuran derived from corn, and the like. The chemical structures for tannic acid, primaine, chitosan, and 2,5-diformylfuran are provided below:

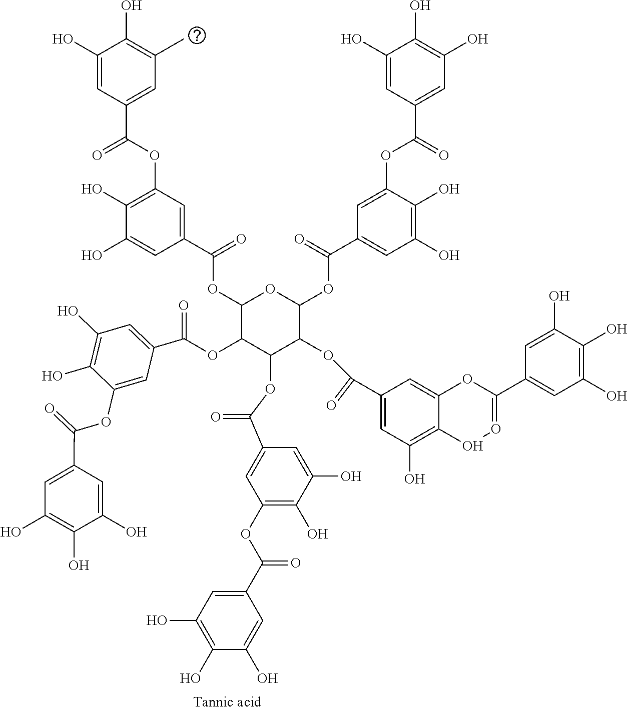

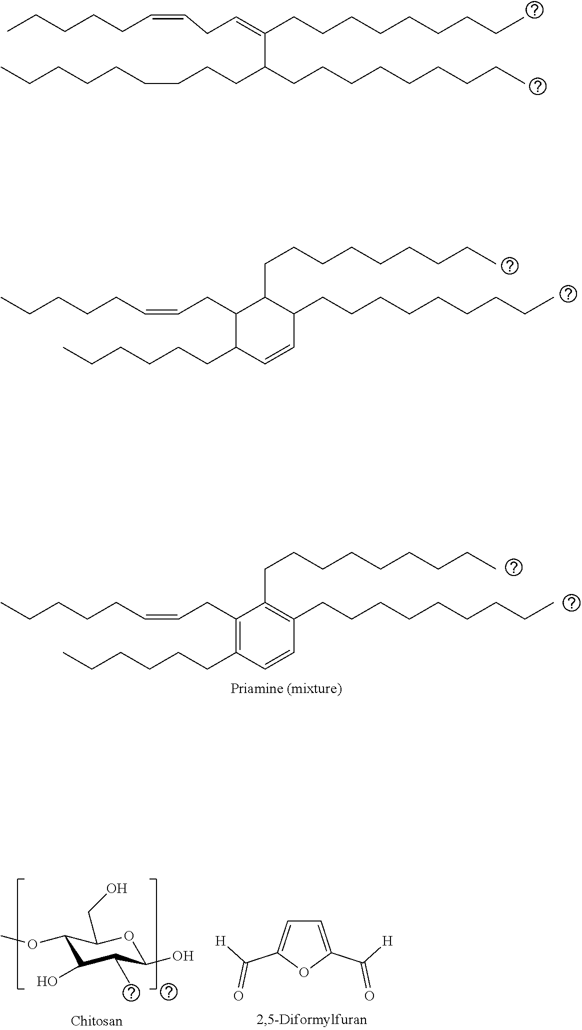

In some embodiments, a natural building block may include a structural segment and at least two functional groups attached to the structural segment. The functional groups attached to the structural segment may be the reactive chemical moieties that participate in the interfacial polymerization reaction and that react to form solvent-resistant bonds linking the structural segments together. The functional groups may include one or more atoms that are a part of the functional group, but that do not participate in the interfacial polymerization reaction and/or do not change after the interfacial polymerization reaction. The structural segment is the portion of the natural building block that supports the functional groups. The structural segment generally does not participate in the interfacial polymerization reaction and/or does not change after the interfacial polymerization reaction. In some cases, the structural segment may include one or more atoms associated with the functional group, but which do not participate in the interfacial polymerization reaction and/or which do not change after the interfacial polymerization reaction.

To form a branched polymer network via interfacial polymerization, one of the natural building block type A and the natural building block type B should be at least bifunctional and the other natural building block should be at least trifunctional. The natural building block type A may include at least two functional groups and the natural building block type B may include at least three functional groups. Alternatively, the natural building block type A may include at least three functional groups and the natural building block type B may include at least two functional groups. In addition to being difunctional or polyfunctional, the natural building block type A and the natural building block type B which are selected to participate in the reaction may include functional groups with complementary reactivity. Examples of suitable functional groups include, without limitation, one or more of a hydroxyl group, an aldehyde group, an amine group, a catechol group, and a pyrogallol group. Any combination of the foregoing functional groups may participate in the reaction to form solvent-resistant bonds.

As used herein, the term “functionality” as in “difunctional” or “bifunctional,” “trifunctional,” “polyfunctional,” and so on refers a number of attachment sites provided on a particular molecule, compound, or building block. The functionality of a particular compound may be related to the number of functional groups present on the compound, at least in cases, for example, where the functional groups are defined as the reactive moieties that participate or that are capable of participating in the reaction. For example, a difunctional natural building block may include two functional groups which are reactive and which may form attachment sites. A trifunctional natural building block may include three functional groups which are reactive and which may form attachment sites. A polyfunctional natural building block may include two or more functional groups which are reactive and which may form attachment sites.

As used herein, the term “green solvent” may refer to a solvent which is environmentally friendly. Like natural building blocks, the green solvents may include solvents derived from one or more of sustainable materials, renewable materials, and natural materials. Examples of suitable green solvents include, without limitation, one or more of water, p-cymene, acetic acid, eucalyptol, γ-valerolactone, PolarClean, DMSO evolution, propylene carbonate, sulfolane, 3,3-dimethyl-2-butanone, dimethyl carbonate, cyclopentyl methyl ether, ethyl L-lactate, cyrene, terpineol, α-pinene, glycerol, butylacetate, 1,2 propanediol, isopropyl acetate, 2-methyltetrahydrofuran, nerol, d-isosorbide, isosorbide dimethyl ether, cardanol, tert-butyl acetate, 4-(hydroxylmethyl)-1,3-dioxolan-2-one, 1-heptanol, cyclopentanone, tert-butanol, (R)-(+)-limonene, (R)-(−)-limonene, 1-butyl-2-pyrrolidone, glycerol 12-carbonate, isobutyl acetate, agnique AMD (propanamide, 2-hydroxy-N, N-dimethyl-), IRIS (dimethyl 2-methylglutarate), 2-methyl-1-propanol, soybean oil methyl ester, and vinyl acetate.

As used herein, the term “solvent-resistant bond” refers to a bond which is stable in the presence of a solvent. The solvent is not particularly limited and may include, for example, harsh solvents, water, organic solvents, and the like. A solvent-resistant bond may include any bond formed by an interfacial polymerization reaction between reactive chemical moieties, or functional groups. The functional groups may be attached to different natural structural segments and/or natural building blocks. Example of solvent-resistant bonds of the present disclosure include, without limitation, one or more of imine bonds, hemiacetal bonds, and carbon-nitrogen single bonds. In some embodiments, the solvent-resistant bonds include imine bonds of formulas (A) and (B), hemiacetal bonds of formula (C), and carbon-nitrogen single bonds of formula (D):

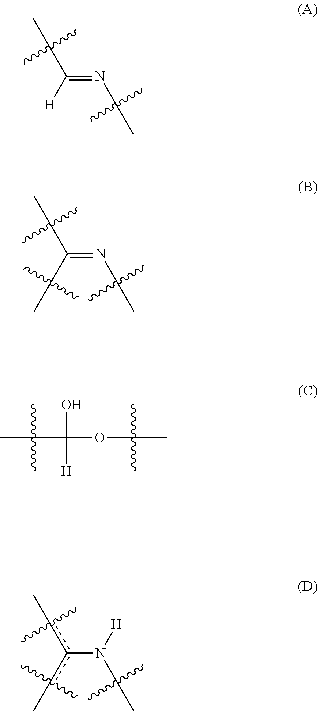

wherein dashed lines represent optional double bonds and open solid lines indicate points of attachment.

Non-limiting examples of solvents in which the solvent-resistant bonds are stable include water, heptane, methyl ethyl ketone, acetonitrile, acetone, isopropanol, ethanol, acetonitrile, tetrahydrofuran, toluene, chloroform, hexane, methanol, acetone, dimethyl sulfoxide (DMSO), dimethylformamide (DMF), n-methyl 2-pyrrolidone (NMP), 1-propanol, 2-propanol, 1-butanol, 1-hexanol, 1-octanol, trifluoroethanol, propylene glycol, PEG 400, 1,3-propanediol, diethyl ether, diglyme, decalin, isooctane, mineral oil, benzene, chlorobenzene, pyridine, ethyl acetate, methyl acetate, dichloroethane, ethylene diamine, and trimethyl phosphate, and the like.

As used herein, the term “a hydroxyl group” refers to —OH.

As used herein, the term “an aldehyde group” refers to —C(═O)H.

As used herein, the term “an amine group” refers to —NR¹R²R³ wherein each of R¹, R², and R³ is independently a hydrogen, an aliphatic, or an aromatic. The term includes primary amines, secondary amines, tertiary amines, quaternary amines, substituted amines, cyclic amines, naturally occurring amines, and the like. Examples of natural building blocks comprising amines include, without limitation, one or more of the following: arginine, betaine, caffeine, choline, N,N′-dibenzylethylenediamine, diethylamine, 2-diethylaminoethanol, 2-dimethylaminoethanol, ethanolamine, ethylenediamine, N-ethylmorpholine, N-ethylpiperidine, glucamine, glucosamine, histidine, hydrabamine, isopropylamine, lysine, methylglucamine, morpholine, piperazine, piperadine, polyamine resins, procaine, purines, theobromine, triethylamine, trimethylamine, tripropylamine, tromethamine and the like.

As used herein, the term “a catechol group” refers to a group having the following chemical structure:

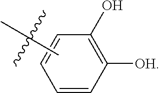

As used. herein, the term “a pyrogallol group” refers to a group having the following chemical structure:

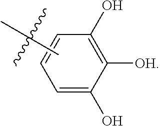

As used herein, the term “aliphatic” refers to an acyclic or cyclic, but non-aromatic compound or group. An aliphatic may optionally include one or more heteroatoms, such as O, N, P, S, and the like.

As used herein, the term “aromatic” refers to unsaturated cyclic hydrocarbon compound or group having a delocalized conjugated π system and having five or more carbon atoms. An aromatic may optionally include one or more heteroatoms, such as O, N, P, S, and the like, in the ring structure. The aromatic may include monocyclic, bicyclic, tricyclic, and/or polycyclic rings, wherein each ring of the aromatic may be fused and/or bridged to another aromatic or aliphatic.

As used herein, the term “molecular weight cutoff” or “MWCO” refers to the molecular weight of a molecule that is 90% retained by the membrane.

### Discussion

The present invention provides nanofilms prepared entirely from sustainable materials and that exhibit excellent stability and separations performance in harsh environments. Embodiments include, for example, nanofilms prepared, either as freestanding nanofilms and/or as nanocomposite films, by interfacial polymerization of natural building blocks. The nanofilms may be prepared without the use of petroleum-based building blocks and polymers. In addition, the preparation of the nanofilms may proceed using only environmentally-friendly solvents (e.g., green solvents). By varying fabrication process parameters, such as concentration and reaction time, among others, the performance, morphology, and composition of the nanofilms may be selectively controlled and finely tuned to meet the requirements of a particular application. The obtained nanofilms are robust and include solvent-resistant bonds which are capable of withstanding (e.g., without dissolving) a multitude of harsh environments including without limitation harsh organic solvents, aqueous solutions of varying pH, and the like. In this way, the nanofilms may be employed as thin film composite membranes or as nanofilm selective layers of thin film composite membranes in a variety of applications, such as organic solvent nanofiltration, water purification/desalination, and wastewater treatment, among others.

Embodiments of the present disclosure thus describe nanofilms and thin film composite membranes comprising said nanofilms. The nanofilms may include one or more of freestanding nanofilms and nanocomposite films which may include a nanofilm supported on a porous substrate. The porous substrate is not particularly limited. Examples of suitable porous substrates include without limitation one or more of a recycled porous conventional polymeric substrate; a cellulose-based porous nanomat, such as starch, chitin, chitosan, alginate, and the like; the polymer-containing natural material, such as seaweed, algae, bamboo, palm, agrowaste, food waste, biomass, and their extracts; and a biodegradable porous polymeric substrate, such as polyhydroxybutyrate (PHB), polylactic acid (PLA), polycaprolactone (PCL), polyethylene glycol (PEG), poly(butylene succinate) (PBS), poly(lactic-co-glycolic acid) (PLGA), poly(ethylene glycol)-co-poly(d,l-lactide) (PELA) and poly(ethylene glycol)-PCL (PEG-PCL), and poly(butylene adipate co-terephtalate) (PBAT) and the like; one or more of a composite porous substrate of the recycled, cellulose-based polymers, and biodegradable polymers, and so on.

In some embodiments, the nanofilm includes the reaction product of at least two types of natural building blocks. The at least two types of natural building blocks may include a natural building block type A and a natural building block type B, wherein the natural building block type A may include at least two functional groups and wherein the natural building block type B may include at least three functional groups. The at least two functional groups of the natural building block type A and the at least three functional groups of the natural building block type B may have complementary reactivity such that a plurality of natural building blocks of the natural building block type A react with a plurality of natural building blocks of the natural building block type B to form a branched polymer network in which a plurality of structural segments are linked by solvent-resistant bonds. In some embodiments, said plurality of structural segments include a structural segment type A which is derived from the natural building block type A and a structural section type B which is derived from the natural building block type B. In other embodiments, one or more additional natural building block types (e.g., natural building block type C, natural building block type D, etc.) may participate in the reaction.

In some embodiments, the nanofilm is the reaction product of an interfacial polymerization reaction. An interfacial polymerization reaction may occur between one or more functional groups of the natural building block type A and one or more functional groups of the natural building block type B. In some embodiments, no functional groups other than the at least two functional groups of the natural building block type A participate, or at least meaningfully participate, in the interfacial polymerization reaction with the at least three functional groups of the natural building block type B Similarly, in some embodiments, no functional groups other than the at least three functional groups of the natural building block type B participate, or at least meaningfully participate, in the interfacial polymerization reaction with the at least two functional groups of the natural building block type A. In some embodiments, the at least two functional groups of the natural building block type A do not react with themselves. In some embodiments, the at least three functional groups of the natural building block type B do not react with themselves. In some embodiments, the at least two functional groups of the natural building block type A and the at least three functional groups of the natural building block type B only react with each other.

In some embodiments, the interfacial polymerization reaction does not involve or proceed in the presence of petrochemical-based building blocks and/or petrochemical-based polymers. In some embodiments, the interfacial polymerization reaction does not involve or proceed in the presence of a crosslinker. In other embodiments, the petrochemical-based aliphatic and/or aromatic building blocks and the crosslinker may include two or more hydroxyl groups, two or more amine groups, two or more acyl chloride groups, two or more epoxy groups, two or more isocyanate groups. In other embodiments, two or more the petrochemical-based building blocks and/or crosslinker are selected to participate in the interfacial polymerization reaction should include functional groups with complementary reactivity. Examples of functional groups with complementary reactivity include, without limitation, a hydroxyl group and an acyl chloride group; a hydroxyl group and an epoxy group; a hydroxyl group and an isocyanate group; an amine group and an acyl chloride group; an amine group and an epoxy group; an amine group and an isocyanate group.

In some embodiments, the functional groups of the natural building block type A and the natural building block type B may include one or more hydroxyl groups, one or more aldehyde groups, one or more amine groups, one or more catechol groups, and/or one or more pyrogallol groups. For example, in some embodiments, each of the at least two functional groups of the natural building block type A is independently a hydroxyl group, an aldehyde group, an amine group, a catechol group, or a pyrogallol group. In some embodiments, each of the at least three functional groups of the natural building block type B is independently a hydroxyl group, an aldehyde group, an amine group, a catechol group, or a pyrogallol group. As mentioned above, the natural building block type A and the natural building block type B that participate or are selected to participate in the interfacial polymerization reaction should include functional groups with complementary reactivity. Examples of functional groups with complementary reactivity include, without limitation, a hydroxyl group and an aldehyde group; an amine group and an aldehyde group; an amine group and a catechol group; and an amine group and a pyrogallol group. Non-limiting examples of reaction schemes involving functional groups with complementary reactivity are shown below:

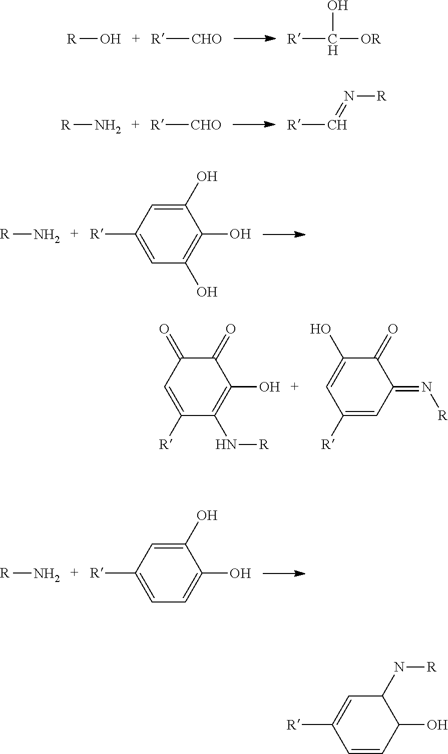

wherein R and R′ may represent a point of attachment to a natural building block (e.g., R and R′ may each be independently one or more aliphatic groups and/or one or more aromatic groups. In some embodiments, any one or more of the functional groups with complementary reactivity form solvent-resistant bonds as a result of Michael addition and/or Schiff base reactions. In some embodiments, the natural building block type A and the natural building block type B may be selected from any natural building blocks that participate in a Schiff base reaction and/or Michael addition reaction.

In some embodiments, one of the natural building block type A and the natural building block type B includes a hydroxyl group and the other natural building block type includes an aldehyde group. In some embodiments, one of the natural building block type A and the natural building block type B includes an amine group and the other natural building block type includes an aldehyde group. In some embodiments, one of the natural building block type A and the natural building block type B includes an amine group and the other natural building block type includes a catechol group. In some embodiments, one of the natural building block type A and the natural building block type B includes an amine group and the other natural building block type includes a pyrogallol group. In some embodiments, the at least two functional groups of the natural building block type A are the same. In other embodiments, one or more of the at least two functional groups may be different. In some embodiments, the at least three functional groups of the natural building block type B are the same. In other embodiments, one or more of the at least three functional groups may be different. In some embodiments, the natural building block type A and the natural building block type B may include one or more functional groups which are the same or different.

In some embodiments, solvent-resistant bonds are formed as a result of the reaction between the functional groups with complementary reactivity as described above. In some embodiments, a nanofilm selective layer includes one or more solvent-resistant bonds. In some embodiments, the solvent-resistant bonds may include one or more of imine bonds, hemiacetal bonds, and carbon-nitrogen single bonds. In some embodiments, a hydroxyl group and an aldehyde group react to form a hemiacetal bond of the formula (1):

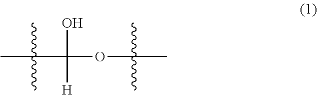 [SMILES: *OC(*)O]

In some embodiments, an amine group and an aldehyde group react to form an imine bond of the formula (2):

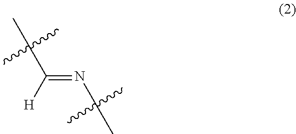 [SMILES: */C=N/*]

In some embodiments, an amine group and a catechol group react to form an imine bond of the formula (3):

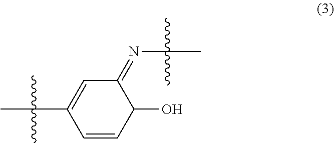 [SMILES: */N=C1/C=C(*)C=CC1O]

In some embodiments, an amine group and a pyrogallol group react to form one or more of an imine bond and a carbon-nitrogen single bond of the formulas (4) and (5), respectively:

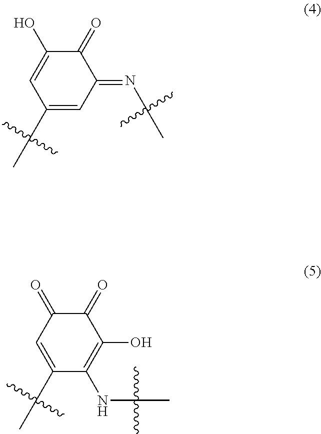 [SMILES: */N=C1\C=C(*)C=C(O)C1=O ; *NC1=C(O)C(=O)C(=O)C=C1*]

In some embodiments, the natural building block type A and the natural building block type B include compounds which are non-synthetic and/or derived from one or more of sustainable sources, renewable sources, and natural sources. Examples of natural building blocks suitable for use as the natural building block type A and/or the natural building block type B include, without limitation, one or more of the following: tannic acid; 2,5-diformylfuran; genipin; spermine; spermidine; agmatine; cadaverine; putrescine; corilagin; dialdehyde celluloses, such as starch dialdehyde, chitosan dialdehyde, chitin dialdehyde, alginate dialdehyde; glycerol, citric acid, lactic acid, tartaric acid, gluconic acid, glucoheptonic acid, sucrose; fructose; maltose; glucose; saccharose; mannitol; sorbitol; arabinose; galactose; mannose; sucrose; ribose; trehalose; lactose; starch; cellulose; gum Arabic; guar; xanthan; alginates; pectin; gellan; D-xylans; arabino-xylans; maltodextrins; and corn syrups. For example, in one embodiment, one of the natural building block type A and the natural building block type B includes tannic acid and the other natural building block type includes priamine In another embodiment, one of the natural building block type A and the natural building block type B includes chitosan and the other natural building block type includes 2,5-diformylfuran. These shall not be limiting as any combination of the natural building blocks/types of the present disclosure may be used herein.

In some embodiments, each natural building block type includes a structural segment and two or more functional groups attached to the structural segment. For example, the natural building block type A may include a structural segment A and at least two functional groups X attached to the structural segment A. Similarly, the natural building block type B may include a structural segment B and at least three functional groups Y attached to the structural segment B. Examples of the natural building block type A include the natural building blocks of formulas (A1) to (A5) and examples of the natural building block type B include the natural building blocks of formulas (B1) to (B5), both of which are shown below.

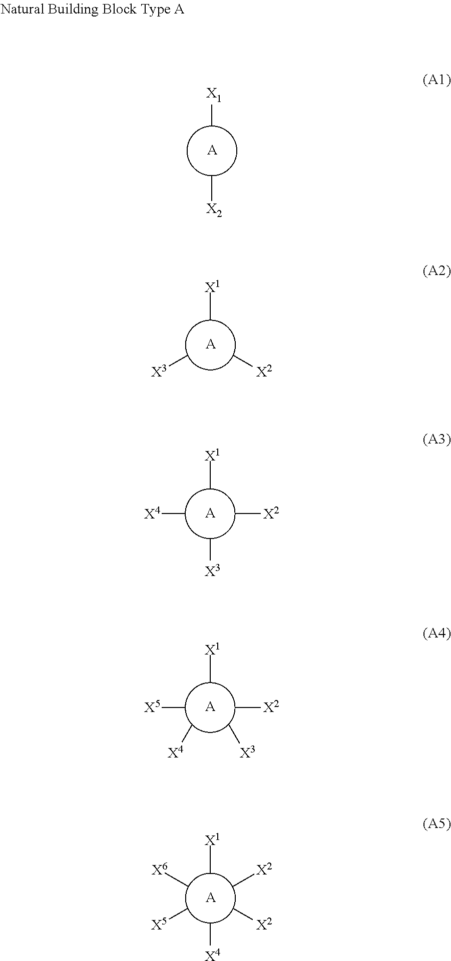

wherein the structural segment A may include one or more aliphatic groups, one or more aromatic groups, or a combination thereof; and wherein the functional groups X¹, X², X³, X⁴, and X⁵, if present, are independently a hydroxyl group, an aldehyde group, an amine group, a catechol group, or a pyrogallol group. While natural building blocks A1 to A5 are shown including from two to six functional groups, in other embodiments, the natural building block A may include more than six functional groups attached to the structural segment A.

In some embodiments, each structural segment A of the natural building block from A1 to A5 includes one or more cyclic ether groups, one or more aliphatic groups, one or more aromatic groups, and/or one or more furan groups. In some embodiments, the structural segment A may include one or more of a cyclic ether group, an aliphatic group, an aromatic group, and a furan group. In some embodiments, each structural segment A of the natural building blocks A include two or more functional groups, wherein the two or more functional groups are independently a hydroxyl group, an aldehyde group, an amine group, a catechol group, or a pyrogallol group.

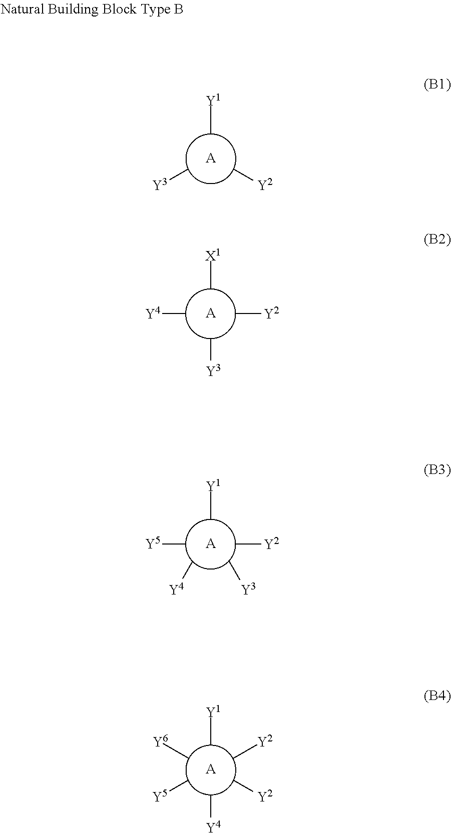

wherein the structural segment B may include one or more aliphatic groups, one or more aromatic groups, or a combination thereof; and wherein the functional groups Y¹, Y², Y³, Y⁴, and Y⁵, if present, are independently a hydroxyl group, an aldehyde group, an amine group, a catechol group, or a pyrogallol group. While natural building blocks B1 to B4 are shown including from three to six functional groups, in other embodiments, the natural building block B may include more than six functional groups attached to the structural segment B.

In some embodiments, each structural segment B of the natural building block from B1 to B4 includes one or more cyclic ether groups, one or more aliphatic groups, one or more aromatic groups, and/or one or more furan groups. In some embodiments, the structural segment B may include one or more of a cyclic ether group, an aliphatic group, an aromatic group, and a furan group. In some embodiments, each structural segment B of the natural building blocks A includes three or more functional groups, wherein the two or more functional groups are independently a hydroxyl group, an aldehyde group, an amine group, a catechol group, or a pyrogallol group.

In some embodiments, the nanofilm includes the reaction product of the natural building block type A and the natural building block type B, wherein the natural building block type A includes one or more of the natural building block of formula A1, the natural building block of formula A2, the natural building block of formula A3, the natural building block of formula A4, and the natural building block of formula A5, and wherein the natural building block type B includes one or more of the natural building block of formula B1, the natural building block of formula B2, the natural building block of formula B3, and the natural building block of formula B4. In some embodiments, each of the functional groups X¹, X², X³, X⁴, and X⁵ of the natural building blocks of formulas A1 to A5, if present, is independently a hydroxyl group, an aldehyde group, an amine group, a catechol group, or a pyrogallol group. In some embodiments, each of the functional groups Y¹, Y², Y³, Y⁴, and Y⁵ of the natural building blocks of formulas B1 to B5, if present is independently a hydroxyl group, an aldehyde group, an amine group, a catechol group, or a pyrogallol group.

In some embodiments, the nanofilm includes the reaction product of the natural building block type A1 and the natural building block type B1, wherein each of the functional groups X and Y are as defined above. In some embodiments, the nanofilm includes the reaction product of the natural building block type A1 and the natural building block type B2, wherein each of the functional groups X and Y are as defined above. In some embodiments, the nanofilm includes the reaction product of the natural building block type A1 and the natural building block type B3, wherein each of the functional groups X and Y are as defined above. In some embodiments, the nanofilm includes the reaction product of the natural building block type A1 and the natural building block type B4, wherein each of the functional groups X and Y are as defined above.

In some embodiments, the nanofilm includes the reaction product of the natural building block type A2 and the natural building block type B1, wherein each of the functional groups X and Y are as defined above. In some embodiments, the nanofilm includes the reaction product of the natural building block type A2 and the natural building block type B2, wherein each of the functional groups X and Y are as defined above. In some embodiments, the nanofilm includes the reaction product of the natural building block type A2 and the natural building block type B3, wherein each of the functional groups X and Y are as defined above. In some embodiments, the nanofilm includes the reaction product of the natural building block type A2 and the natural building block type B4, wherein each of the functional groups X and Y are as defined above.

In some embodiments, the nanofilm includes the reaction product of the natural building block type A3 and the natural building block type B1, wherein each of the functional groups X and Y are as defined above. In some embodiments, the nanofilm includes the reaction product of the natural building block type A3 and the natural building block type B2, wherein each of the functional groups X and Y are as defined above. In some embodiments, the nanofilm includes the reaction product of the natural building block type A3 and the natural building block type B3, wherein each of the functional groups X and Y are as defined above. In some embodiments, the nanofilm includes the reaction product of the natural building block type A3 and the natural building block type B4, wherein each of the functional groups X and Y are as defined above.

In some embodiments, the nanofilm includes the reaction product of the natural building block type A4 and the natural building block type B1, wherein each of the functional groups X and Y are as defined above. In some embodiments, the nanofilm includes the reaction product of the natural building block type A4 and the natural building block type B2, wherein each of the functional groups X and Y are as defined above. In some embodiments, the nanofilm includes the reaction product of the natural building block type A4 and the natural building block type B3, wherein each of the functional groups X and Y are as defined above. In some embodiments, the nanofilm includes the reaction product of the natural building block type A4 and the natural building block type B4, wherein each of the functional groups X and Y are as defined above.

In some embodiments, the nanofilm includes the reaction product of the natural building block type A5 and the natural building block type B1, wherein each of the functional groups X and Y are as defined above. In some embodiments, the nanofilm includes the reaction product of the natural building block type A5 and the natural building block type B2, wherein each of the functional groups X and Y are as defined above. In some embodiments, the nanofilm includes the reaction product of the natural building block type A5 and the natural building block type B3, wherein each of the functional groups X and Y are as defined above. In some embodiments, the nanofilm includes the reaction product of the natural building block type A5 and the natural building block type B4, wherein each of the functional groups X and Y are as defined above.

Examples of natural building blocks with varying functionalities and the structures resulting from interfacial polymerization of those natural building blocks are presented below to illustrate the various types of branched polymer networks which may be formed (e.g., as reaction products) in accordance with the invention. From these examples, the multitude of structures capable of being formed from the wide array of natural building block types disclosed herein will be readily appreciated and thus the examples shall not be limiting.

In some embodiments, the nanofilm includes the reaction product of the natural building block type A and the natural building block type B to form the representative portion of the branched polymer network shown below:

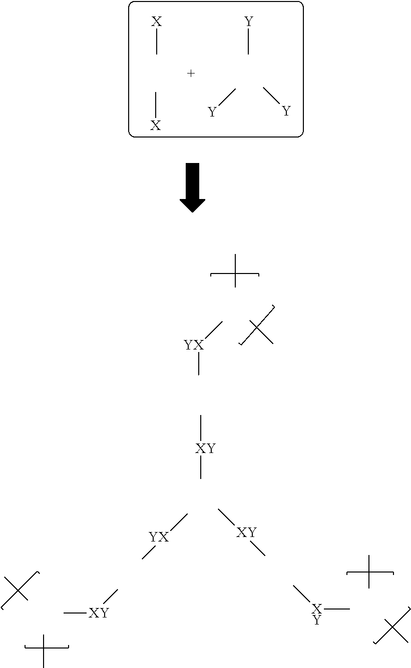

wherein each of X and Y independently includes functional groups as defined herein and wherein XY and YX include solvent-resistant bonds as defined herein.

In some embodiments, for example, the nanofilm includes the reaction product of the natural building block type A and the natural building block type B to form the representative portion of the branched polymer network shown below:

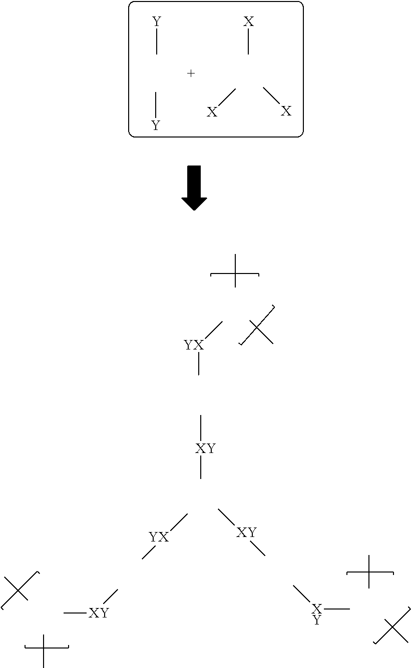

wherein each of X and Y independently includes functional groups as defined herein and wherein XY and YX include solvent-resistant bonds as defined herein.

In some embodiments, for example, the nanofilm includes the reaction product of the natural building block type A and the natural building block type B to form the representative portion of the branched polymer network shown below:

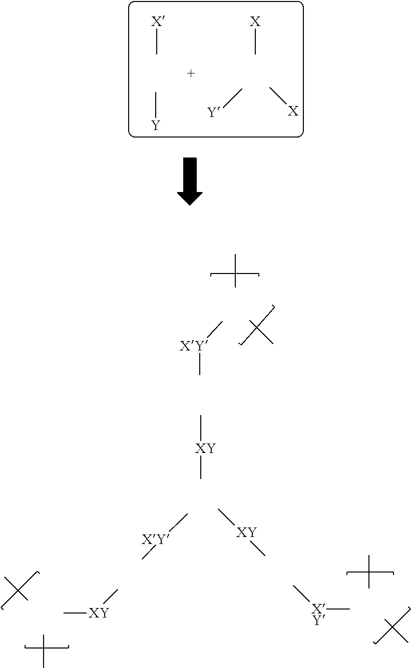

wherein each of X, X′, Y, and Y′ independently includes functional groups as defined herein and wherein XY and YX include solvent-resistant bonds as defined herein.

In some embodiments, for example, the nanofilm includes the reaction product of the natural building block type A and the natural building block type B to form the representative portion of the branched polymer network shown below:

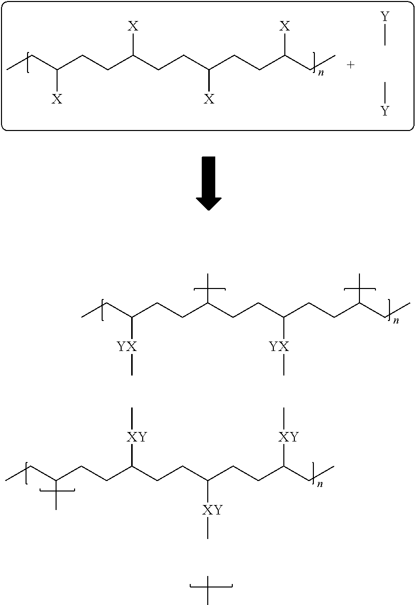

wherein each of X and Y independently includes functional groups as defined herein; wherein XY and YX include solvent-resistant bonds as defined herein; and n is from 1 to 100000.

In some embodiments, for example, the nanofilm includes the reaction product of the natural building block type A and the natural building block type B to form the representative portion of the branched polymer network shown below:

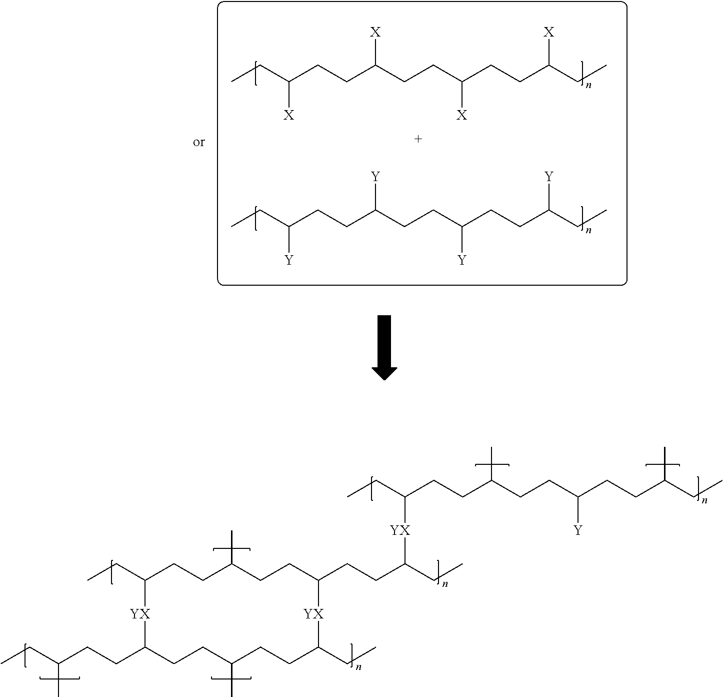

wherein each of X and Y independently includes functional groups as defined herein; wherein XY and YX include solvent-resistant bonds as defined herein; and n is from 1 to 100000.

In some embodiments, the nanofilms, either as freestanding nanofilms and/or nanocomposite films, may be used as thin film composite membranes or as nanofilm selective layers of thin film composite membranes. Embodiments thus further include thin film composite membranes comprising the nanofilms of the present disclosure. The thin film composite membranes may be used for organic solvent nanofiltration (which is also known as solvent-resistant nanofiltration (SRNF) and organophilic nanofiltration), water purification such as water desalination, wastewater treatment, and the like. Having tunable and/or modifiable properties, the thin film composite membranes may be used in industrial applications requiring low molecular weight cutoffs. For example, in some embodiments, the thin film composite membranes are used in applications involving one or more of solvent recovery, waste stream concentration, recovery of small-sized catalysts and in particular organocatalysts, removal of small-size impurities (e.g., genotoxins, etc.), and the like. The thin film composite membranes may also be used in industrial applications requiring high molecular weight cutoffs. For example, in some embodiments, the thin film composite membranes are used in applications for enrichment and/or concentration of large solutes, including, without limitation, active pharmaceutical ingredients, macrocycles, polymers, catalysts and in particular metal-based catalysts, and the like.

A thickness of the thin film composite membrane and/or nanofilm can range from about 1 nm to about 1 μm, inclusive. In some embodiments, the thickness of the thin film composite membrane and/or nanofilm is about 30 nm. In some embodiments, the thickness of the thin film composite membrane and/or nanofilm is about 40 nm. In some embodiments, the thickness of the thin film composite membrane and/or nanofilm is about 60 nm. In some embodiments, the thickness of the thin film composite membrane and/or nanofilm is about 80 nm. In some embodiments, the thickness of the thin film composite membrane and/or nanofilm is about 95 nm. In other embodiments, the thickness of the thin film composite membrane and/or nanofilm may include any value or subrange between about 1 nm to about

A molecular weight cutoff of the thin film composite membrane and/or nanofilm can range from about 100 g mol⁻¹ to about 2000 g mol⁻¹. In some embodiments, the molecular weight cutoff of the thin film composite membrane and/or nanofilm ranges from about 200 g mol⁻¹ to about 800 g mol⁻¹. In some embodiments, the molecular weight cutoff of the thin film composite membrane and/or nanofilm is about 495 g mol⁻¹. In some embodiments, the molecular weight cutoff of the thin film composite membrane and/or nanofilm is about 395 g mol⁻¹. In some embodiments, the molecular weight cutoff of the thin film composite membrane and/or nanofilm is about 795 g In some embodiments, the molecular weight cutoff of the thin film composite membrane and/or nanofilm is about 295 g mol⁻¹. In some embodiments, the molecular weight cutoff of the thin film composite membrane and/or nanofilm is about 236 g mol⁻¹. In other embodiments, the molecular weight cutoff of the thin film composite membrane and/or nanofilm may include any value or subrange between about 100 g mol⁻¹ to about 2000 g mol⁻¹.

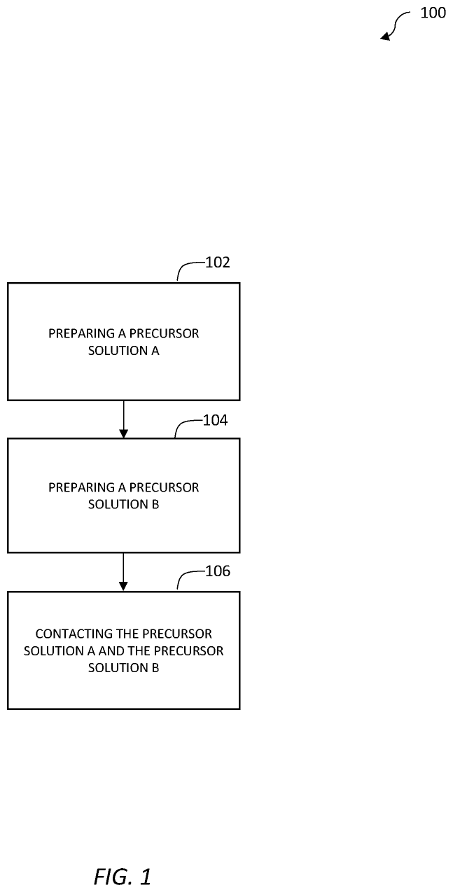

FIG. 1 is a flowchart of a method of making a nanofilm, according to one or more embodiments of the invention. As shown in FIG. 1, the method 100 may include preparing 102 a precursor solution A including a natural building block type A dissolved in a green solvent A, wherein the natural building block type A includes at least two functional groups; preparing 104 a precursor solution B including a natural building block type B dissolved in a green solvent B, wherein the natural building block B includes at least three functional groups; and contacting 106 the precursor solution A and the precursor solution B to form, by interfacial polymerization, a nanofilm including a branched polymer network and solvent-resistant bonds. In some embodiments, the solvent-resistant bonds may link at least a portion of the natural building block type A (e.g., structural segment type A) to at least a portion of the natural building block type B (e.g., structural segment type B). In some embodiments, the natural building block type A includes a plurality of building blocks A, each of the plurality of building blocks A including the at least two functional groups. In some embodiments, the natural building block type B includes a plurality of building blocks B, each of the plurality of building blocks B including the at least three functional groups.

The precursor solution A may be prepared in step 102 by combining, optionally under stirring, the natural building block type A (e.g., the plurality of natural building blocks of the natural building block type A) and the green solvent A in a reaction vessel. Similarly, the precursor solution B may be prepared in step 104 by combining, optionally under stirring, the natural building block type B (e.g., the plurality of natural building blocks of the natural building block type B) and the green solvent B in the same reaction vessel or in a separate reaction vessel. Once the natural building block type A has been combined with and/or dissolved in the green solvent A and once the natural building block type B has been combined with and/or dissolved in the green solvent B, the precursor solution A and the precursor solution B may be contacted in step 106 to initiate the interfacial polymerization reaction which forms the branched polymer network and/or the solvent-resistant bonds. The manner in which the contacting 106 is performed permits control over the type of nanofilm to be formed. For example, depending on the manner in which the contacting is performed, either freestanding nanofilms may be fabricated or nanocomposite films in which the nanofilm is supported on a porous substrate may be fabricated.

For example, in some embodiments, the fabrication of a freestanding nanofilm includes preparing the precursor solution A and the precursor solution B. For example, the precursor solution A may include the natural building block type A dissolved in the green solvent A. Similarly, the precursor solution B may include the natural building block type B dissolved in the green solvent B. The precursor solution A may be prepared in the reaction vessel and the precursor solution B may be added to the reaction vessel containing the precursor solution A to initiate the interfacial polymerization reaction. Alternatively, the precursor solution A may be transferred to the reaction vessel and, once transferred, the precursor solution may be added to the reaction vessel to initiate the interfacial polymerization reaction. Being at least partially immiscible with each other, upon being contacted in this way, the precursor solution A and the precursor solution B may form an interface where the interfacial polymerization reaction is carried out and where the freestanding nanofilm is formed. In other embodiments, the precursor solution B may be prepared in the reaction vessel or transferred to the reaction vessel and then contacted with the precursor solution A.

In some embodiments, the fabrication of a nanocomposite film may include preparing the precursor solution A in a reaction vessel and the precursor solution B in a separate reaction vessel. As described above, the precursor solution A may include the natural building block type A dissolved in the green solvent A, and the precursor solution B may include the natural building block type B dissolved in the green solvent B. A porous support may be immersed in the reaction vessel containing the precursor solution A. Through capillary forces, the precursor solution A is provided in the pores and on the surface of the porous substrate. The porous substrate may then be removed from the precursor solution A and excess precursor solution A may be removed or discarded. The porous support may then be immersed in the precursor solution B to initiate the interfacial polymerization reaction and form the nanocomposite film including the nanofilm supported on the porous substrate. In other embodiments, the porous substrate may be immersed in the precursor solution B and thereafter immersed in the precursor solution A.

The green solvent A and the green solvent B may independently include one or more solvents. To carry out the interfacial polymerization reaction, the green solvent A and the green solvent B should be immiscible or at least partially immiscible with each other such that an interface is formed upon contacting the precursor solution A and the precursor solution B. In addition, the green solvent A should be suitable for dissolving the natural building block type A Similarly, the green solvent B should be suitable for dissolving the natural building block type B. In some embodiments, the green solvent A and the green solvent B may be non-solvents for the other natural building blocks. For example, in some embodiments, the green solvent A is not a solvent in which the natural building block B dissolves. In some embodiments, the green solvent B is not a solvent in which the natural building block A dissolves.

In some embodiments, the green solvent A and the green solvent B independently include one or more of water, p-cymene, acetic acid, eucalyptol, g-valerolactone, polarClean, DMSO evolution, propylene carbonate, sulfolane, 3,3-dimethyl-2-butanone, dimethyl carbonate, cyclopentyl methyl ether, ethyl L-lactate, cyrene, terpineol, α-pinene, glycerol, butylacetate, 1,2 propanediol, isopropyl acetate, 2-methyltetrahydrofuran, nerol, d-isosorbide, isosorbide dimethyl ether, cardanol, tert-butyl acetate, 4-(hydroxylmethyl)-1,3-dioxolan-2-one, 1-heptanol, cyclopentanone, tert-butanol, (R)-(+)-limonene, (R)-(−)-limonene, 1-butyl-2-pyrrolidone, glycerol 12-carbonate, isobutyl acetate, agnique AMD (propanamide, 2-hydroxy-N,N-dimethyl-), IRIS (dimethyl 2-methylglutarate), 2-methyl-1-propanol, soybean oil methyl ester, and vinyl acetate. In some embodiments, one of the green solvent A and the green solvent B includes water and the other green solvent includes one or more organic solvents. For example, in some embodiments, the green solvent A may include water and the green solvent B may include an organic solvent. In some embodiments, the green solvent B may include water and the green solvent A may include an organic solvent. In some embodiments, one of the green solvent A and the green solvent B include p-cymene and the other green solvent includes water. In some embodiments, one of the green solvent A and the green solvent B include water and acetic acid and the other green solvent includes eucalyptol.

The concentration of the natural building block type A in the precursor solution A may range from about 0.01% (w/v) to about 90% (w/v) of the total precursor solution A volume (e.g., the combined volume of the natural building block type A and one or more green solvents A). The concentration of the natural building block type B in the precursor solution B may range from about 0.01% (w/v) to about 90% (w/v) of the total precursor solution B volume (e.g., the combined volume of the natural building block type B and one or more green solvents B).

The conditions under which the interfacial polymerization reaction is performed are not particularly limited. In some embodiments, the reaction is carried out at ambient temperature and/or ambient pressure. In other embodiments, the reaction is carried out at other temperatures and/or pressures. For example, in some embodiments, the reaction is carried out at temperatures ranging from about −15 degrees C. to about 100 degrees C. In some embodiments, the reaction is carried out at pressures ranging from about 0 bar to about 75 bar. The reaction time may range from about greater than zero seconds to about less than 10 minutes, or any incremental value or subrange between that range. For example, in some embodiments, the reaction time is about 5 minutes.

The performance, morphology, and/or composition of the nanofilms and/or thin film composite membranes may be controlled by the selection of natural building block types, reaction time of the interfacial polymerization, and/or the natural building block type concentration of precursor solutions, among other film fabrication process parameters. For example, in some embodiments, increasing reaction time may increase one or more of thickness and tightness of the nanofilm and/or thin film composite membrane. In some embodiments, increasing reaction time may decrease flux through the nanofilm and/or thin film composite membrane. In some embodiments, increasing reaction time may decrease molecular weight cutoff of the nanofilm and/or thin film composite membrane.

In some embodiments, increasing the concentration of a natural building block type having one or more amine functional groups may increase thickness of the nanofilm and/or thin film composite membrane. In some embodiments, increasing the concentration of a natural building block type having one or more amine functional groups may decrease flux through the nanofilm and/or thin film composite membrane. In some embodiments, increasing the concentration of a natural building block type having one or more amine functional groups may have no appreciable impact on the molecular weight cutoff of the nanofilm and/or thin film composite membrane.

In some embodiments, increasing the concentration of a natural building block type having one or more hydroxyl groups, one or more catechol groups, and/or one or more pyrogallol groups may decrease molecular weight cutoff of the nanofilm and/or thin film composite membrane. In some embodiments, increasing the concentration of a natural building block type having one or more hydroxyl groups, one or more catechol groups, and/or one or more pyrogallol groups may decrease flux through the nanofilm and/or thin film composite membrane. In some embodiments, increasing the concentration of a natural building block type having one or more hydroxyl groups, one or more catechol groups, and/or one or more pyrogallol groups may have no appreciable impact on the thickness of the nanofilm and/or thin film composite membrane.

In some embodiments, increasing a polarity of an organic solvent may increase the flux of said solvent through the nanofilm and/or thin film composite membrane. In some embodiments, increasing a concentration of a natural building block having one or more aldehyde groups may decrease a flux through the nanofilm and/or thin film composite membrane.

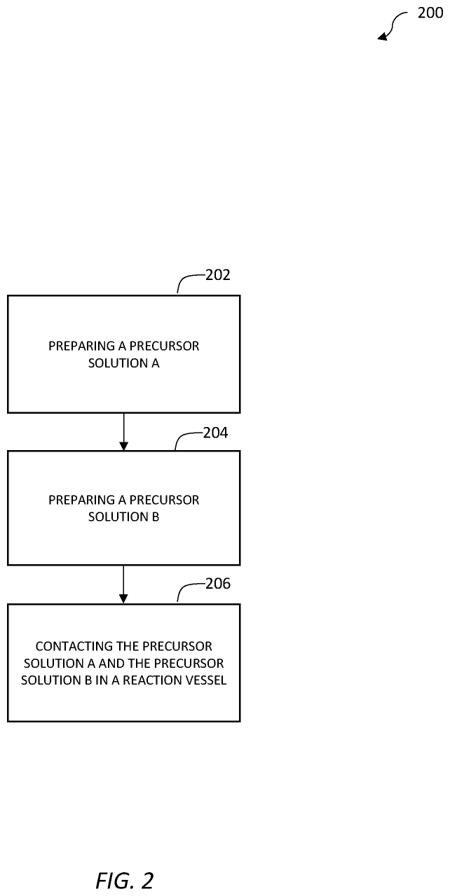

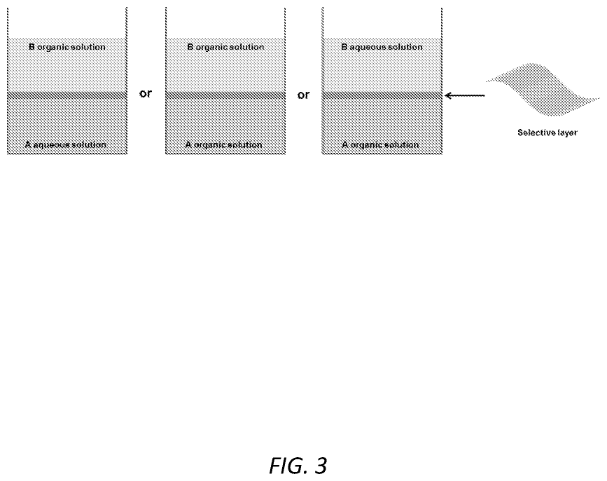

FIG. 2 is a flowchart of a method 200 of making a nanofilm, according to one or more embodiments of the invention. As shown in FIG. 2, the method 200 may include one or more of the following steps, which may be performed in any order: preparing 202 a precursor solution A including a plurality of natural building blocks A dissolved in a green solvent A, each of the plurality of natural building blocks A including two or more functional groups; preparing 204 a precursor solution B including a plurality of natural building blocks B dissolved in a green solvent B, each of the plurality of natural building blocks B including three or more functional groups; and contacting 206 the precursor solution A and the precursor solution B in a reaction vessel to form, by interfacial polymerization, a freestanding nanofilm. Schematic diagrams illustrating various methods of making freestanding nanofilms are shown in FIGS. 3A-3C, according to one or more embodiments of the invention.

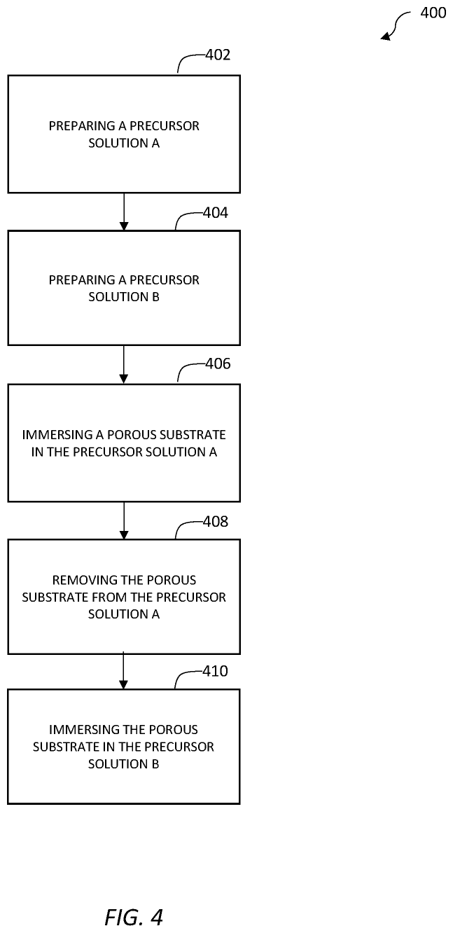

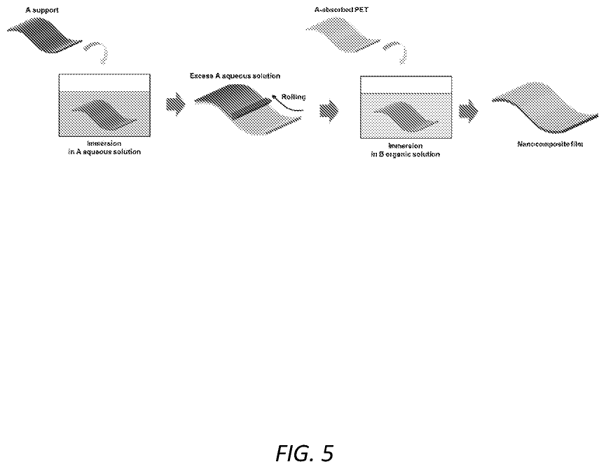

FIG. 4 is a flowchart of a method 400 of making a nanocomposite film, according to one or more embodiments of the invention. As shown in FIG. 4, the method 400 may include one or more of the following steps, which may be performed in any order: preparing 402 a precursor solution A including a plurality of natural building blocks A dissolved in a green solvent A, each of the plurality of natural building blocks A including two or more functional groups; preparing 404 a precursor solution B including a plurality of natural building blocks B dissolved in a green solvent B, each of the plurality of natural building blocks B including three or more functional groups; immersing 406 a porous substrate in the precursor solution A; removing 408 the porous substrate from the precursor solution A and optionally excess precursor solution A from the porous substrate; and immersing 410 the porous substrate in the precursor solution B to form, by interfacial polymerization, a nanocomposite film. A schematic diagram illustrating a method of making a nanocomposite film is shown in FIG. 5, according to one or more embodiments of the invention.

The precursor solutions employed in the methods 100, 200 and 400 may include any combination of the natural building blocks, structural segments, functional groups, and green solvents disclosed herein. Accordingly, the nanofilms thus may similarly include any structure resulting from a reaction involving said precursor solutions. For example, the nanofilms may include any combination of the structural segments (e.g., from the natural building blocks) and solvent-resistant bonds (e.g., formed by reaction of the functional groups) disclosed herein.

### EXAMPLE 1

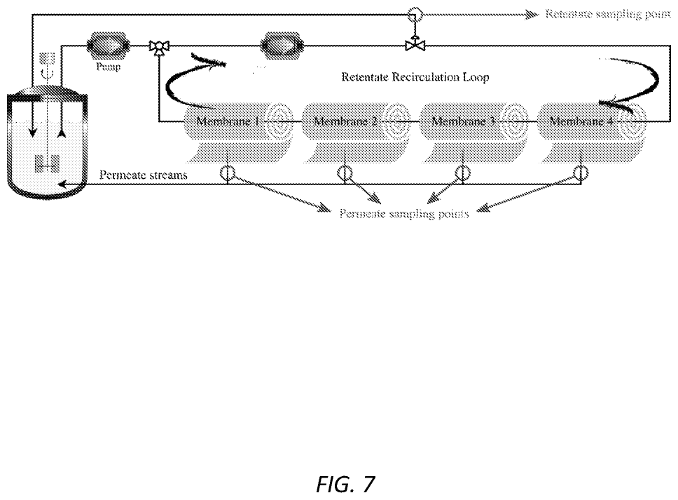

To prepare the nanofilm, about 1.6 g L⁻¹ of priamine was dissolved in p-cymene to form a first solution and about 1.7 g L⁻¹ concentration of tannic acid was dissolved in water to form a second solution. The first solution was contacted with the second solution to carry out the interfacial polymerization reaction. The reaction time was about 0.5 min. The resulting nanofilm exhibited OSN performance with a flux of about 210 L m⁻²h⁻¹ in acetone solvent at about 10 bar applied pressure. FIG. 7 is a schematic diagram of a multistage crossflow nanofiltration apparatus used for the filtration tests of the films in the examples 1 to 29. The crossflow equipment type present in FIG. 7 may be used for commercial and/or industrial production processes. For example, the equipment can be used at small production scale, for example in pharma or biopharma, and in some specialty chemicals. The equipment may also be scaled-up for petrochemical separations to cope with high throughput. The scaled-up versions of the equipment will have the same or similar features.

### EXAMPLE 2

To prepare the nanofilm, about 1.6 g L⁻¹ concentration of priamine in p-cymene solvent in combination with 1.7 g L⁻¹ concentration of tannic acid in water with reaction time of 1 min. This nanofilm demonstrated OSN performance with flux 182 L m⁻²h⁻¹ in acetone solvent at 10 bar applied pressure.

### EXAMPLE 3

To prepare the nanofilm, about 1.6 g L⁻¹ concentration of priamine in p-cymene solvent in combination with 1.7 g L⁻¹ concentration of tannic acid in water with reaction time of 2 min resulted in a nanofilm with 60 nm thickness. This nanofilm demonstrated OSN performance with flux of 165 L m⁻²h⁻¹ in acetone solvent at 10 bar applied pressure.

### EXAMPLE 4

To prepare the nanofilm, about 1.6 g L⁻¹ concentration of priamine in p-cymene solvent in combination with 1.7 g L⁻¹ concentration of tannic acid in water with reaction time of 3 min resulted in a nanofilm with 60 nm thickness. This nanofilm demonstrated OSN performance with 495 g mol⁻¹ molecular weight cut-off and flux of 106 L m⁻²h⁻¹ in acetone solvent at 10 bar applied pressure.

### EXAMPLE 5

To prepare the nanofilm, about 1.6 g L⁻¹ concentration of priamine in p-cymene solvent in combination with 1.7 g L^{-b 1} concentration of tannic acid in water with reaction time of 5 min resulted in a nanofilm with 80 nm thickness. This nanofilm demonstrated OSN performance with 395 g mol⁻¹ molecular weight cut-off and flux of 91 L m⁻²h⁻¹ in acetone solvent at 10 bar applied pressure.

### EXAMPLE 6

To prepare the nanofilm, about 0.053 g L⁻¹ concentration of priamine in p-cymene solvent in combination with 1.7 g L⁻¹ concentration of tannic acid in water with reaction time of 5 min resulted in a nanofilm with 40 nm thickness. This nanofilm demonstrated OSN performance with 395 g mol⁻¹ molecular weight cut-off and flux of 169 L m⁻²h⁻¹ in acetone solvent at 10 bar applied pressure.

### EXAMPLE 7

To prepare the nanofilm, about 0.27 g L⁻concentration of priamine in p-cymene solvent in combination with 1.7 g L⁻¹ concentration of tannic acid in water with reaction time of 5 min resulted in a nanofilm with 40 nm thickness. This nanofilm demonstrated OSN performance with 395 g mol⁻¹ molecular weight cut-off and flux of 157 L m⁻²h⁻¹ in acetone solvent at 10 bar applied pressure.

### EXAMPLE 8

To prepare the nanofilm, about 0.53 g L⁻¹ concentration of priamine in p-cymene solvent in combination with 1.7 g L⁻¹ concentration of tannic acid in water with reaction time of 5 min resulted in a nanofilm with 80 nm thickness. This nanofilm demonstrated OSN performance with 395 g mol⁻¹ molecular weight cut-off and flux of 135 L m⁻²h⁻¹ in acetone solvent at 10 bar applied pressure.

### EXAMPLE 9

To prepare the nanofilm, about 2.65 g L⁻¹ concentration of priamine in p-cymene solvent in combination with 1.7 g L⁻¹ concentration of tannic acid in water with reaction time of 5 min resulted in a nanofilm with 95 nm thickness. This nanofilm demonstrated OSN performance with 395 g mol⁻¹ molecular weight cut-off and flux of 57 L m⁻²h⁻¹ in acetone solvent at 10 bar applied pressure.

### EXAMPLE 10

To prepare the nanofilm, about 0.053 g L⁻¹ concentration of priamine in p-cymene solvent in combination with 0.017 g L⁻¹ concentration of tannic acid in water with reaction time of 5 min resulted in a nanofilm with 30 nm thickness. This nanofilm demonstrated OSN performance with 795 g mol⁻¹ molecular weight cut-off and flux of 195 L m⁻²h⁻¹ in acetone solvent at 10 bar applied pressure.

### EXAMPLE 11

To prepare the nanofilm, about 0.053 g L⁻¹ concentration of priamine in p-cymene solvent in combination with 0.085 g L⁻¹ concentration of tannic acid in water with reaction time of 5 min resulted in a nanofilm with 30 nm thickness. This nanofilm demonstrated OSN performance with 395 g mol⁻¹ molecular weight cut-off and flux of 159 L m⁻²h⁻¹ in acetone solvent at 10 bar applied pressure.

### EXAMPLE 12

To prepare the nanofilm, about 0.053 g L⁻¹ concentration of priamine in p-cymene solvent in combination with 0.17 g L⁻¹ concentration of tannic acid in water with reaction time of 5 min resulted in a nanofilm with 30 nm thickness. This nanofilm demonstrated OSN performance with 236 g mol⁻¹ molecular weight cut-off and flux of 137 L m⁻²h⁻¹ in acetone solvent at 10 bar applied pressure.

### EXAMPLE 13

To prepare the nanofilm, about 0.053 g L⁻¹ concentration of priamine in p-cymene solvent in combination with 0.85 g L⁻¹ concentration of tannic acid in water with reaction time of 5 min resulted in a nanofilm with 30 nm thickness. This nanofilm demonstrated OSN performance with 295 g mol⁻¹ molecular weight cut-off and flux of 151 L m⁻²h⁻¹ in acetone solvent at 10 bar applied pressure.

### EXAMPLE 14

To prepare the nanofilm, about 0.053 g L⁻¹ concentration of priamine in p-cymene solvent in combination with 0.17 g L⁻¹ concentration of tannic acid in water with reaction time of 5 min resulted in a nanofilm with 30 nm thickness. This nanofilm demonstrated OSN performance with flux of 31 L m⁻²h⁻¹ in heptane solvent at 10 bar applied pressure.

### EXAMPLE 15

To prepare the nanofilm, about 0.053 g L⁻¹ concentration of priamine in p-cymene solvent in combination with 0.17 g L⁻¹ concentration of tannic acid in water with reaction time of 5 min resulted in a nanofilm with 30 nm thickness. This nanofilm demonstrated OSN performance with flux of 37 L m⁻²h⁻¹ in toluene solvent at 10 bar applied pressure.

### EXAMPLE 16

To prepare the nanofilm, about 0.053 g L⁻¹ concentration of priamine in p-cymene solvent in combination with 0.17 g L⁻¹ concentration of tannic acid in water with reaction time of 5 min resulted in a nanofilm with 30 nm thickness. This nanofilm demonstrated OSN performance with flux of 56 L m⁻²h⁻¹ in ethanol solvent at 10 bar applied pressure.

### EXAMPLE 17

To prepare the nanofilm, about 0.053 g L⁻¹ concentration of priamine in p-cymene solvent in combination with 0.17 g L⁻¹ concentration of tannic acid in water with reaction time of 5 min resulted in a nanofilm with 30 nm thickness. This nanofilm demonstrated OSN performance with flux of 128 L m⁻²h⁻¹ in methyl ethyl ketone solvent at 10 bar applied pressure.

### EXAMPLE 18

To prepare the nanofilm, about 0.053 g L⁻¹ concentration of priamine in p-cymene solvent in combination with 0.17 g L⁻¹ concentration of tannic acid in water with reaction time of 5 min resulted in a nanofilm with 30 nm thickness. This nanofilm demonstrated OSN performance with flux of 223 L m⁻²h⁻¹ in acetonitrile solvent at 10 bar applied pressure.

### EXAMPLE 19

To prepare the nanofilm, about 0.012 g L⁻¹ concentration of 2,5-diformylfuran in eucalyptol solvent in combination with 0.088 g L⁻¹ concentration of chitosan in water with reaction time of 5 min. This nanofilm demonstrated OSN performance with flux of 317 L m⁻² h⁻¹ in acetone solvent at 10 bar applied pressure.

### EXAMPLE 20

To prepare the nanofilm, about 0.06 g L⁻¹ concentration of 2,5-diformylfuran in eucalyptol solvent in combination with 0.088 g L⁻¹ concentration of chitosan in water with reaction time of 5 min. This nanofilm demonstrated OSN performance with flux of 292 L m⁻² h⁻¹ in acetone solvent at 10 bar applied pressure.

### EXAMPLE 21

To prepare the nanofilm, about 0.12 g L⁻¹ concentration of 2,5-diformylfuran in eucalyptol solvent in combination with 0.088 g L⁻¹ concentration of chitosan in water with reaction time of 5 min. This nanofilm demonstrated OSN performance with flux of 245 L m⁻² h⁻¹ in acetone solvent at 10 bar applied pressure.

### EXAMPLE 22

To prepare the nanofilm, about 0.18 g L⁻¹ concentration of 2,5-diformylfuran in eucalyptol solvent in combination with 0.088 g L⁻¹ concentration of chitosan in water with reaction time of 5 min. This nanofilm demonstrated OSN performance with flux of 201 L m⁻²h⁻¹ in acetone solvent at 10 bar applied pressure.

### EXAMPLE 23

To prepare the nanofilm, about 0.36 g L⁻¹ concentration of 2,5-diformylfuran in eucalyptol solvent in combination with 0.088 g L⁻¹ concentration of chitosan in water with reaction time of 5 min. This nanofilm demonstrated OSN performance with flux of 121 L m⁻²h⁻¹ in acetone solvent at 10 bar applied pressure.

### EXAMPLE 24

The 30 nm film obtained using 0.053 g L⁻¹ priamine in p-cymene and 0.17 g L⁻¹ tannic acid in water with 5 min reaction time demonstrated a tight structure capable of effective separation of solutes at the lower end of the nanofiltration range: 90% rejection of 236 g mol⁻¹, 92% rejection of 295 g mol⁻¹, 100% rejection of 1195 g mol⁻¹ styrene-derivatives in acetone solvent at 10 bar.

### EXAMPLE 25

The 30 nm film obtained using 0.053 g L⁻¹ priamine in p-cymene and 0.017 g L⁻¹ tannic acid in water with 5 min reaction time demonstrated an open structure capable of effective separation of solutes at the higher end of the nanofiltration range: 70% rejection of 236 g mol⁻¹, 75% rejection of 295 g mol⁻¹, 97% rejection of 1900 g mol⁻¹ styrene-derivatives in acetone solvent at 10 bar.

### EXAMPLE 26

The 30 nm film obtained using 0.053 g L⁻¹ priamine in p-cymene and 0.17 g L⁻¹ tannic acid in water with 5 min reaction time demonstrated a stable filtration performance with respect to both permeance and rejection of styrene dimer over a one-week period with permeance values being 2.6 L m⁻²h⁻¹ at day 1, 2.6 L m⁻²h⁻¹ at day 2, 2.6 L m⁻²h⁻¹ at day 3, 2.6 L m⁻²h⁻¹ at day 4, 2.5 L m⁻²h⁻¹ at day 5, 2.5 L m⁻²h⁻¹ at day 6, 2.5 L m⁻²h⁻¹ at day 7; and with rejection values being 92% at day 1, 92% at day 2, 92% at day 3, 92% at day 4, 92% at day 5, 92% at day 6, 92% at day 7, in heptane solvent at 10 bar in a cross-flow filtration rig.

### EXAMPLE 27

The 30 nm film obtained using 0.053 g L⁻¹ priamine in p-cymene and 0.17 g L⁻¹ tannic acid in water with 5 min reaction time demonstrated a stable filtration performance with respect to both permeance and rejection of styrene dimer over a one-week period with permeance values being 3.5 L m⁻²h⁻¹ at day 1, 3.5 L m⁻²h⁻¹ at day 2, 3.5 L m⁻²h⁻¹ at day 3, 3.5 L m⁻²h⁻¹ at day 4, 3.4 L m⁻²h⁻¹ at day 5, 3.4 L m⁻²h⁻¹ at day 6, 3.4 L m⁻²h⁻¹ at day 7; and with rejection values being 75% at day 1, 75% at day 2, 75% at day 3, 75% at day 4, 75% at day 5, 75% at day 6, 75% at day 7, in toluene solvent at 10 bar in a cross-flow filtration rig.

### EXAMPLE 28

The film obtained using 0.38 g L⁻¹2,5-diformylfuran in eucalyptol and 0.088 g L⁻1 of chitosan in water with 5 min reaction time demonstrated a tight structure capable of effective separation of solutes at the lower end of the nanofiltration range: 85% rejection of 236 g mol⁻¹, 89% rejection of 295 g mol⁻¹, 100% rejection of 1095 g mol⁻¹ styrene-derivatives in acetone solvent at 10 bar.

### EXAMPLE 29

The film obtained using 0.012 g L⁻¹ 2,5-diformylfuran in eucalyptol and 0.088 g L⁻¹ of chitosan in water with 5 min reaction time demonstrated a tight structure capable of effective separation of solutes at the lower end of the nanofiltration range: 60% rejection of 236 g mol⁻¹, 68% rejection of 295 g mol⁻¹, 100% rejection of 1500 g mol⁻¹ styrene-derivatives in acetone solvent at 10 bar.

1. A nanofilm comprising: the reaction product of a natural building block type A including at least two functional groups and a natural building block type B including at least three functional groups, wherein one of the natural building block type A and the natural building block type B include at least two functional groups and the other natural building block type includes at least three functional groups, and wherein the natural building block type A and the natural building block type B react to form a branched polymer network including solvent-resistant bonds.

2. The nanofilm according to claim 1, wherein each of the at least two functional groups of the natural building block type A or the natural building block type B is independently a hydroxyl group, an aldehyde group, an amine group, a catechol group, or a pyrogallol group.

3. The nanofilm of claim 1, wherein each of the at least three functional groups of the natural building block type A or the natural building block type B is independently a hydroxyl group, an aldehyde group, an amine group, a catechol group, or a pyrogallol group.

4. The nanofilm of claim 1, wherein the at least two functional groups of the natural building block type A or the natural building block type B are different from the at least three functional groups of the other natural building block.

5. The nanofilm of claim 1, wherein the solvent-resistant bonds link at least a portion of the natural building block type A to at least a portion of the natural building block type B.

6. The nanofilm of claim 1, wherein the solvent-resistant bonds include one or more of an imine bond, a hemiacetal bond, a carbon-nitrogen single bond, carbon-carbon single bond, carbon-carbon double bond, carbon-oxygen bond, carbon-sulfur single bond, carbon-sulfur double bond, and sulfur-sulfur double bond.

7. The nanofilm of claim 1, wherein at least one of the functional groups of the natural building block type A is a hydroxyl group and at least one of the functional groups of the natural building block type B is an aldehyde group.

8. The nanofilm according to claim 7, wherein the hydroxyl group and the aldehyde group react to form a hemiacetal bond of formula (1):

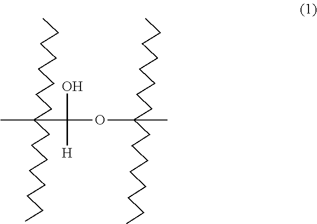 [SMILES: CCCCCCCCC(C)(CCCCCCCC)O[C@H](O)C(C)(CCCCCCCC)CCCCCCCC]

9. The nanofilm of claim 1, wherein at least one of the functional groups of the natural building block type A is an amine group and at least one of the functional groups of the natural building block type B is an aldehyde group.

10. The nanofilm according to claim 9, wherein the amine group and the aldehyde group react to form an imine bond of the formula (2):

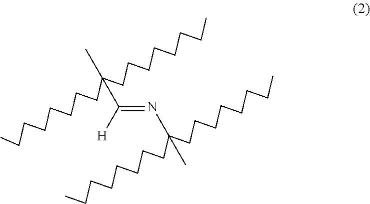 [SMILES: CCCCCCCCC(C)(/C=N/C(C)(CCCCCCCC)CCCCCCCC)CCCCCCCC]

11. The nanofilm of claim 1, wherein at least one of the functional groups of the natural building block type A is an amine group and at least one of the functional groups of the natural building block type B is a catechol group.

12. The nanofilm according to claim 11, wherein the amine group and the catechol group react to form an imine bond of the formula (3):

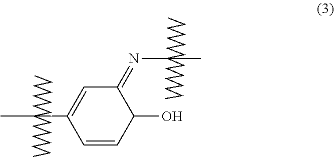 [SMILES: CCCCCCCCC(C)(CCCCCCCC)/N=C1/C=C(C(C)(CCCCCCCC)CCCCCCCC)C=CC1O]

13. The nanofilm of claim 1, wherein at least one of the functional groups of the natural building block type A is an amine group and at least one of the functional groups of the natural building block type B is a pyrogallol group.

14. The nanofilm according to 13, wherein the amine group and the pyrogallol group react to form an imine bond and a carbon-nitrogen single bond of the formulas (4) and (5):

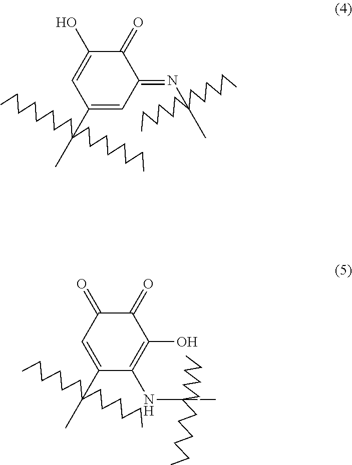

15. The nanofilm of claim 1, wherein the natural building block type A and the natural building block type B are independently selected from chitosan, priamine, 2,5-diformylfuran, tannic acid, corilagin, starch dialdehyde, chitosan dialdehyde, chitin dialdehyde, and alginate dialdehyde.

16. The nanofilm of claim 1, wherein a thickness of the nanofilm ranges from about 1 nm to about 2000 nm.

17. The nanofilm of claim 1, wherein a molecular weight cutoff of the nanofilm ranges from about 100 g mol to about 2000 g mol

18. A thin film composite membrane for organic solvent nanofiltration comprising the nanofilm of claim 1.

19. A thin film composite membrane for one or more of water purification and wastewater treatment comprising the nanofilm of claim 1.

20. A method of making a nanofilm comprising:
preparing a precursor solution A including a natural building block type A dissolved in a green solvent A, wherein the natural building block type A includes two or more functional groups;
preparing a precursor solution B including a natural building block type B dissolved in a green solvent B, wherein the natural building block type B includes three or more functional groups; and
contacting the precursor solution A and the precursor solution B to form, by interfacial polymerization, to form a branched polymer network including solvent-resistant bonds.
